(19) United States
(12) Patent Application Publication
(10) Pub. No.: US 2012/0261185 A1
(43) Pub. Date: Oct. 18, 2012

(54) WIRING HARNESS

(75) Inventors: Satoshi Murao, Yokkaichi-shi (JP); Takehiro Hosokawa, Yokkaichi-shi (JP); Masashi Sato, Yokkaichi-shi (JP); Tetsuya Iwasaki, Yokkaichi-shi (JP); Masanobu Yoshimura, Yokkaichi-shi (JP); Yukihiro Sakamoto, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/511,450

(22) PCT Filed: Dec. 22, 2010
(86) PCT No.: PCT/JP2010/073163

§ 371 Date: Jun. 25, 2012

(30) Foreign Application Priority Data
Dec. 25, 2009 (JP) 2009-294852

(51) Int. Cl. H02G 3/02

(52) U.S. Cl. 174/72 A

(57) ABSTRACT

Provided is a wiring harness that has favorable radiation performance, is capable of achieving a reduced space for wiring, and allows an easy wiring task. A wiring harness includes three single flat cables, each of which has a flat shape in cross section in a width direction and includes a conductor having a flat shape and an insulator with which the conductor is coated, wherein the single flat cables are disposed in parallel in the width direction in a protection member where the flat cables are prevented from overlapping each other.

### TECHNICAL FIELD

The present invention relates to a wiring harness including flat cables.

### BACKGROUND ART

Conventionally, a wiring harness 101 is used for wiring in a power supply circuit of an automobile, where the wiring harness 101 is used with a relatively large electric current, the wiring harness 101 including about three round wires 102 (single wires) having a relatively large diameter, each of which is prepared by coating a conductors 103 having a cross-sectional area of 15 mm² or more with an insulator 104, where the three round wires 102 are covered with a shielding layer 105 and an armoring member 106, whereby the three round wires 102 are bunched together as shown in FIGS. 7A and 7B.

In these days, a flat cable (a Flexible Flat Cable, hereinafter called to also as an FFC) is used for wiring in an automobile. The FFC has a larger surface area than the round wire and accordingly has improved radiation performance. Thus, a conductor of the FFC can be reduced in size. In addition, the FFC is very flat and flexible, which brings about an advantage such that the space for wiring can be reduced, and the FFC is foldable in a narrow space.

For example, laminated flat cables including a plurality of flat cables that are laminated are known as cables used for electric wiring in an automobile (see PTL 1).

### Citation List

### Patent Literature

PTL 1: JP2008-117781A

### SUMMARY OF INVENTION

### Technical Problem

While the FFC has the larger surface area and accordingly has the improved radiation performance, the radiation is prevented if the FFCs are laminated completely to each other or overlap each other, which tends to cause a rise in temperature of the conductors. For this reason, the laminated configuration of the FFCs is unfavorable for the use where a large electric current is passed.

In addition, the radiation is prevented if the cables overlap each other, even if the FFCs do not have a laminated configuration. To solve this problem, wiring paths need to be prepared such that the cables do not overlap each other in wiring the FFCs; however, the wiring paths are limited. In addition, paying sufficient attention such that the cables do not overlap each other in wiring the FFCs is a very troublesome task.

The object to be solved by the present invention is to provide a wiring harness that has favorable radiation performance, is capable of achieving a reduced space for wiring, and allows an easy wiring task in wiring a plurality of flat cables that are bunched together.

### Solution to Problem

In order to solve the problems described above, a wiring harness of the present invention includes plurality of single flat cables, each of which has a flat shape in cross section in a width direction, and includes a conductor having a flat shape and an insulator with which the conductor is coated, wherein the single flat cables are disposed in parallel in the width direction where the flat cables are prevented from overlapping each other.

### Advantageous Effects of Invention

Having the configuration that the plurality of single flat cables having the flat shape in cross section in the width direction and including the conductors having the flat shape and the insulators with which the conductors are coated, wherein the single flat cables are disposed in parallel in the width direction, the wiring harness of the present invention is capable of achieving a reduced space for wiring because the wiring harness of the present invention has a flatter shape as a whole than a conventional wiring harness including round wires.

In addition, having the configuration that the plurality of single flat cables are disposed in parallel in the width direction, which is not a laminated configuration such that the plurality of single flat cables are laminated vertically, the wiring harness of the present invention has favorable radiation performance. In addition, because the single flat cables are already disposed so as not to overlap each other, wiring paths for the flat cables are not limited in wiring the flat cables, and there is no possibility of temperature rise caused by degraded radiation performance of the wiring harness due to overlapping flat cables. Thus, favorable heat radiation from the single flat cables can be performed.

In addition, because the single flat cables are already disposed so as not to overlap each other, wiring paths for the wiring harness are not limited in wiring, so that it is unnecessary to pay attention such that the cables do not overlap each other in wiring, which allows an easy wiring task.

### BRIEF DESCRIPTION OF DRAWINGS

FIGS. 1A and 1B are views showing a wiring harness of a preferred embodiment of the present invention, where FIG. 1A is a cross-sectional view in a width direction, and FIG. 1B is a plan view.

FIG. 2 is a cross-sectional view showing a protection member of the wiring harness shown in FIGS. 1A and 1B.

FIGS. 3A and 3B are cross-sectional views in the width direction showing configurations of single flat cables.

FIG. 4 is a cross-sectional view in the width direction showing the wiring harness of another preferred embodiment of the present invention.

FIG. 5A is a cross-sectional view in the width direction showing the wiring harness of another preferred embodiment of the present invention, and FIG. 5B is a cross-sectional view showing a state where a protection member shown in FIG. 5A is disassembled.

FIG. 6A is a cross-sectional view in the width direction showing the protection member of another preferred embodiment of the present invention, and FIG. 6B is a cross-sectional view in the width direction showing the wiring harness including the protection member shown in FIG. 6A.

FIGS. 7A and 7B are views showing a conventional wiring harness, where FIG. 1A is a cross-sectional view in a width direction, and FIG. 1B is a plan view.

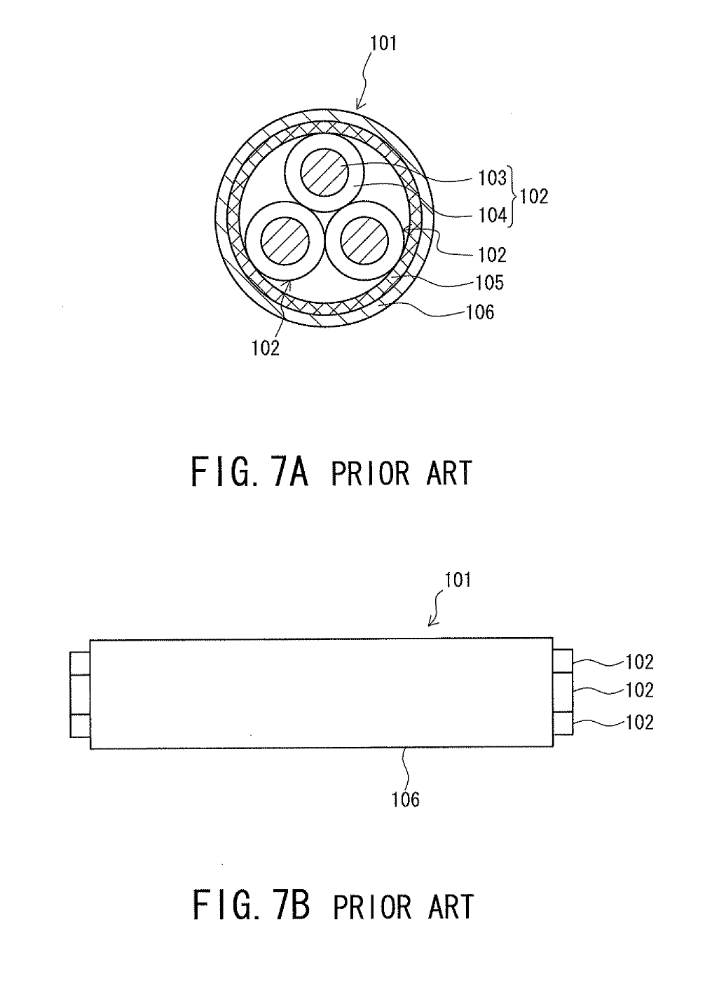

FIGS. 8A and 8B are views for illustrating a method for deciding an electric current value such that ΔT becomes 70 degrees C. (a saturation value).

### DESCRIPTION OF EMBODIMENTS

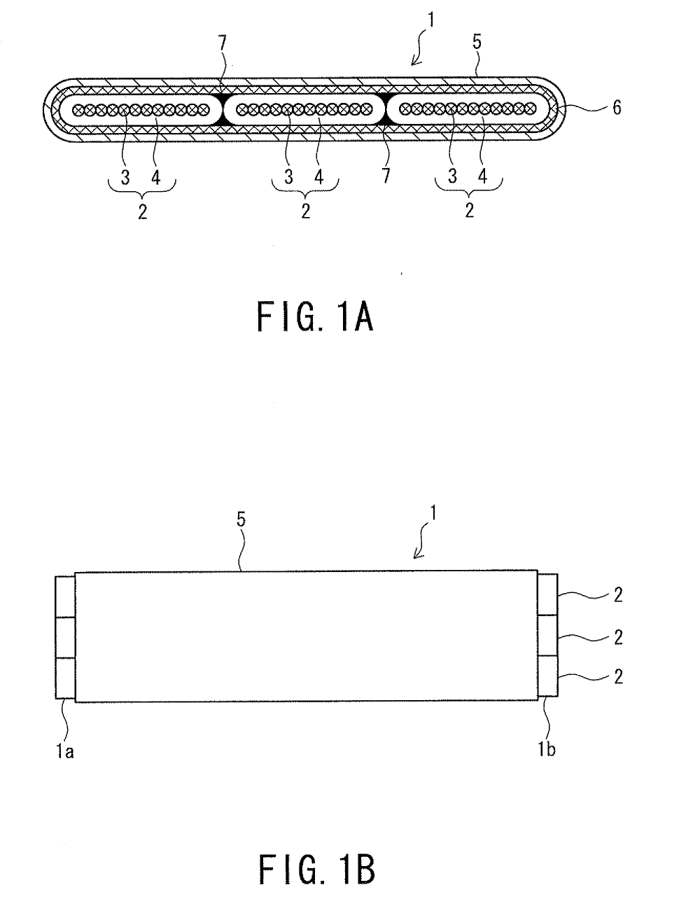

A detailed description of a wiring harness of a first preferred embodiment of the present invention will now be provided with reference to the accompanying drawings. FIGS. 1A and 1B are views showing the wiring harness of the present embodiment of the present invention, where FIG. 1A is a cross-sectional view in a width direction, and FIG. 1B is a plan view. A wiring harness 1 of the present embodiment of the present invention includes a plurality of single flat cables 2 (three single flat cables in the embodiment shown in FIGS. 1A and 1B) that are disposed adjacent to each other in parallel in a width direction (in a horizontal direction in FIG. 1A) as shown in FIGS. 1A and 1B. In the wiring harness 1, the single flat cables 2 are housed in a protection member 5 so as not to overlap each other.

FFCs of a same configuration are used for the single flat cables 2. Each single flat cable 2 includes a conductor 3 having a flat shape, and an insulator with which the conductor 3 is coated. Each single flat cable 2 has a flat shape in cross section in the width direction.

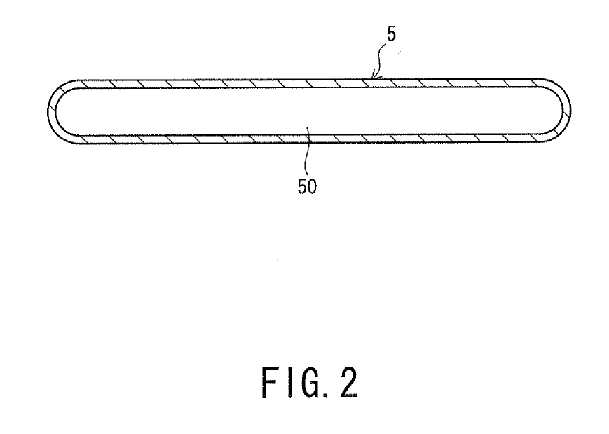

FIG. 2 is a cross-sectional view showing a protection member of the wiring harness shown in FIGS. 1A and 1B. A protection member 5 includes one housing space 50 that is capable of housing a plurality of (three) single flat cables disposed in parallel as shown in FIG. 2. The protection member 5 has a tube-shaped body having a flat shape in cross section in a width direction. The three single flat cables 2 are housed in the housing space 50 of the protection member 5.

The protection member 5 has the function of protecting the single flat cables 2 from the outside, and the function of holding the plurality of single flat cables 2 so as to prevent them from overlapping each other. By including the protection member 5, the wiring harness 1 can maintain its shape even if bent, and keep the single flat cables disposed in parallel. Thus, the wiring harness 1 can prevent in a convincing way degradation in radiation performance resulting from overlapping of flat cables.

Further, the wiring harness 1 includes a shielding layer 6 for proving shielding characteristics between the single flat cables 2 and the protection member 5 as shown in FIGS. 1A and 1B. Gaps between the single flat cables 2 are filled with a filler 7 that defines a liquid resin that is injected and cured, and thus a gap inside the protection member 5 is filled up. When a gap inside the wiring harness 1 is filled with the filler 7, an air layer does not exist there, which improves thermal conductivity inside the wiring harness 1 to improve radiation performance.

A corrugated tube is preferably used as the protection member 5 . It is preferable that the protection member 5 is made from a material that has an improved adhesion property to the single flat cables 2. The improved adhesion property between the protection member 5 and the single flat cables 2 prevents formation of a gap therebetween, which improves thermal conductivity, and accordingly improves radiation performance. A thermoplastic resin is used for the material of the protection member 5, and a polyimide resin and a polypropylene resin are preferably used. The protection member 5 is formed by extrusion-molding the thermoplastic resin so as to have a hollow shape.

End portions of single flat cables 2 at one end la and the other end lb of the wiring harness 1 are exposed out of the ends of the protection member 5 as shown in FIG. 1B. In addition, the adjacent single flat cables 2 are not connected to one another but are separated at the ends of the wiring harness 1. The end portions of single flat cables 2 are individually movable. With this configuration, the wiring harness 1 has an advantage such that in connecting the end portions of single flat cables 2 to other terminals, the end portions of the cables 2 can be easily stripped and connected.

Each single flat cable 2 includes one conductor 3 . A gathering member of stranded wires that consist of elemental wires and are disposed in the width direction, a gathering member of elemental wires that are disposed in the width direction, or a single wire having a flat shape such as a rectangular conductor can be used as the conductor 3. Using the gathering members of stranded wires or elemental wires as the conductors 3 provides flexibility to the conductors 3.

When the conductors 3 are flexible, the single flat cable 2 improves in flexibility. The single flat cable 2 that improves in flexibility improves in adhesion property to the protection member 5, which improves radiation performance. In addition, when the single flat cable 2 improves in flexibility, the wiring harness 1 accordingly improves in flexibility. Thus, the wiring harness 1 is easy to bend in wiring, which facilitates a wiring task. In addition, if the conductors 3 are flexible in the single flat cable 2, an adhesion property of the conductors 3 to the insulators 4 improves.

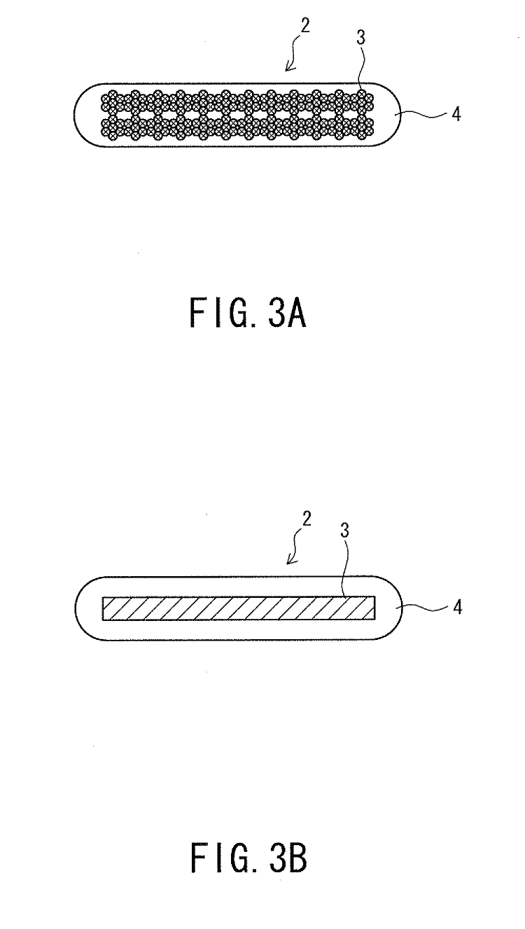

FIGS. 3A and 3B are cross-sectional views in the width direction showing configurations of single flat cables. In each conductor 3 of the single flat cables 2, a laminated member such that elemental wires or stranded wires are laminated vertically is preferably used as the gathering member of stranded wires of elemental wires. The single flat cable 2 shown in FIG. 3A includes a laminated member as the conductor 3, the laminated member having a configuration such that the stranded wires that are disposed in the width direction are laminated vertically, and the insulator 4 with which the conductor 3 is coated. The single flat cable 2 shown in FIG. 38 includes a rectangular conductor having a flat shape in cross section in the width direction as the conductor 3, and the insulator 4 with which the conductor 3 is coated.

The conductors 3 are made from a metal such as copper, a copper alloy, aluminum and an aluminum alloy. Examples of the copper and the copper alloy include oxygen free copper, tough pitch copper, and phosphor bronze. It is preferable that the conductors 3 are plated with a metal such as tin and nickel.

The size of the conductors 3 is determined as appropriate according to the intended use of the wiring harness 1 and the size of the flat cables 2.

Examples of the shielding layer 6 include a metallic braid, and a thin film layer of a metal such as aluminum. It is essential only that the shielding layer 6 should provide shielding characteristics to the wiring harness 1. The metallic thin film layer can be formed on an inner surface of the protection member by evaporating aluminum thereon, or by laminating an aluminum film thereon.

The wiring harness 1 possessing shielding characteristics can prevent an influence exerted by electromagnetic waves on surrounding devices when used in a high-voltage circuit. In addition, the metallic braid if used as the shielding layer 6 has an effect of improving radiation performance because metal has favorable thermal conductivity.

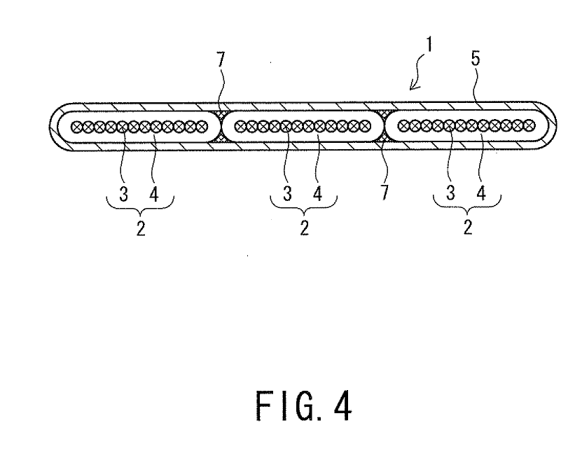

FIG. 4 is a cross-sectional view in the width direction showing the wiring harness of another preferred embodiment of the present invention. The wiring harness 1 shown in FIG. 4 includes no shielding layer as a separate member, but the protection member 5 possesses shielding characteristics. Using the protection member 5 possessing shielding characteristics eliminates the necessity to provide a shielding layer, which can reduce the number of components used in the wiring harness 1.

Shielding characteristics are provided to the protection member 5 preferably using a method of dispersing an electromagnetic wave absorption material such as ferrite particles into the protection member 5, or a method of burying a braid inside of the protection member 5. In order to disperse the ferrite particles into the protection member 5, the ferrite particles are added to the resin from which the protection member 5 is made, and then extrusion-molding of the protection member 5 is performed. In order to bury the braid inside of the protection member 5, the metallic braid is placed inside of a mold, and then the resin is extrusion-molded, whereby the braid and the protection member 5 have a monolithic construction to provide the protection member 5 inside of which the braid is buried.

A material that is in a liquid state before curing and becomes like rubber by being subjected to curing after filling is used as the filler 7. Examples of the filler 7 include liquid silicone rubber. The filler 7 in a liquid state is charged into the gap between the single flat cables 2 and the protection member 5, and then cured at room temperature or by heating. The liquid silicone rubber after subjected to curing becomes like rubber, and lies between the single flat cables 2 and the protection member 5, whereby the heat generated by the single flat cables 2 can be efficiently radiated outside.

An example of the method for producing the wiring harness 1 shown in FIG. 1 will be described. The single flat cables 2 are prepared in advance in a known method. The protection member 5 including the shielding layer 6 is prepared. The single flat cables 2 are inserted into the protection member 5. Then, the filler 7 such as a liquid silicone is charged into the gap between the single flat cables 2 and the protection member 5, and then cured. Thus the wiring harness 1 including the single flat cables 2 that are fixed while disposed in parallel so as not to overlap each other is produced.

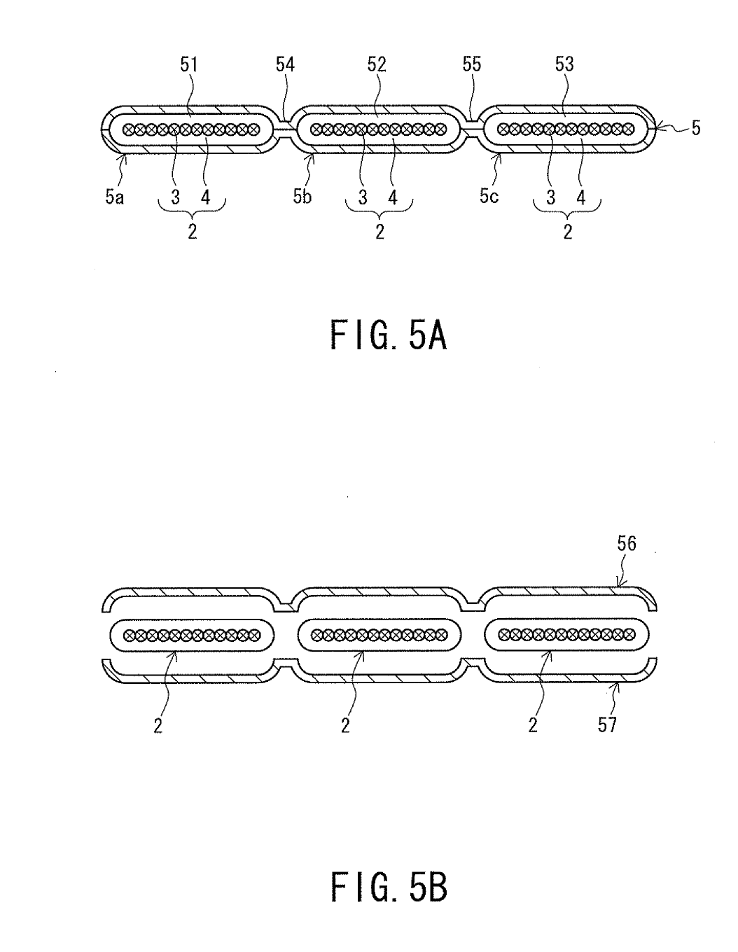

In the wiring harness 1 of the present invention, the shape of the protection member 5 is not limited to the shape described above in the present embodiment. It is essential only that the protection member 5 has a shape such that the state where the single flat cables 2 disposed in parallel can be maintained. FIG. 5A is a cross-sectional view in a width direction showing the wiring harness of another preferred embodiment of the present invention. In the wiring harness 1 shown in FIG. 5A, the protection member 5 includes tubular members 5a, 5b and 5c that include housing spaces 51, 52 and 53 respectively that are arranged to each house the single flat cables 2, a connecting member 54 arranged to connect the tubular members 5a and 5b in the width direction, and a connecting member 55 arranged to connect the tubular members 5b and 5c in the width direction. When the single flat cables 2 are housed in the housing spaces 51, 52 and 53 of the tubular members 5a, 5b and 5c of the protection member 5, the three single flat cables 2 are disposed in the width direction while held by the protection member 5. Thus, the wiring harness 1 is obtained.

FIG. 5B is a cross-sectional view showing a state where the protection member shown in FIG. 5A is disassembled. It is also preferable that the protection member 5 has a configuration of including a pair of an upper protection member 56 and a lower protection member 57 as shown in FIG. 53 that are formed by splitting the protection member 5 in two in the width direction. In the protection member 5 having this configuration, openings are provided to the housing spaces 51, 52 and 53 . For example, the protection member 5 is disassembled, and the single flat cables 2 are disposed at predetermined positions of the lower protection member 57. Then, the upper protection member 56 is placed over the single flat cables 2 on the lower protection member 57, and the upper protection member 56 and the lower protection member 57 are assembled. The upper protection member 56 and the lower protection member 57 are assembled by means for fixing them at a predetermined position on outer surfaces of the upper protection member 56 and the lower protection member 57 with the use of a banding member, or by means of bonding them with the use of an adhesive. The configuration of the protection member 5 that is split in two allows the single flat cables 2 to be easily housed in the housing spaces 51, 52 and 53.

Alternatively, it is also preferable that the protection member 5 has a configuration of including the tubular members 5a, 5b and 5c, each of which defines a mere tubular housing member that cannot be split in two in the width direction. In this case, the single flat cables 2 are inserted into the housing spaces 51, 52 and 53 from one end portions of the tubular members 5a, 5b and 5c.

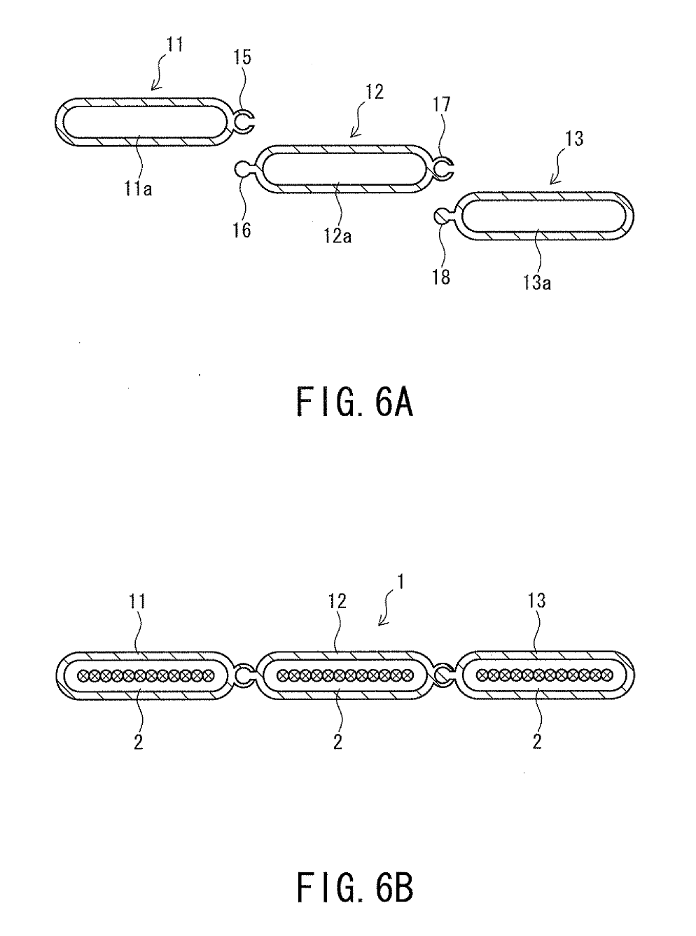

FIG. 6A is a cross-sectional view in the width direction showing the protection member of another preferred embodiment of the present invention, and FIG. 6B is a cross-sectional view in the width direction showing the wiring harness including the protection member shown in FIG. 6A. The protection member 5 shown in FIG. 6A includes a plurality of protection member units 11, 12 and 13 that are connected to each other. The protection member units 11, 12 and 13 include housing spaces 11a, 12a and 13a disposed inside respectively that are arranged to each house the plurality of single flat cables 2, and connecting members 15, 16, 17 and 18 disposed on their lateral sides.

The connecting members 15 and 17 of the protection member units 11 and 12 define concave grooves that have a circular shape in section. The connecting members 16 and 18 define convex ridges that are arranged to fit into the concave grooves of the connecting members 15 and 17. The connecting member 16 of the protection member unit 12 fits into the connecting member 15 of the protection member unit 11, and the connecting member 18 of the protection member unit 13 fits into the connecting member 17 of the protection member unit 12.

As shown in FIG. 6B, the single flat cables 2 are housed in the housing spaces 11a, 12a and 13a of the protection member units 11, 12 and 13 shown in FIG. 6A, and the protection member units 11, 12 and 13 are connected to each other by the connecting members 15, 16, 17 and 18 disposed on their lateral sides. Thus, the wiring harness 1 is obtained in which the plurality of single flat cables 2 are disposed in parallel in the width direction.

The wiring harness 1 can be obtained in which four or more than four single flat cables 2 are disposed in parallel by connecting in the width direction a plurality of the protection member units 12 that are used for middle positions as shown in FIG. 6A such that the connecting members 15 and 17 fit into each other, and connecting the protection member units 11 and 13 at both ends thereof in the width direction.

The number of single flat cables 2 is not limited to three in the present invention, and may be two, or four or more . The single flat cables 2 consisting of three cables of the wiring harness, which is the wiring harness of the preferred embodiments of the present invention, can be favorably used for cables used in a three-phase motor.

The wiring harness of the present invention can be favorably used in a low-voltage circuit or a high-voltage circuit of an automobile.

### EXAMPLE

A description of the present invention will now be provided.

### Example 1

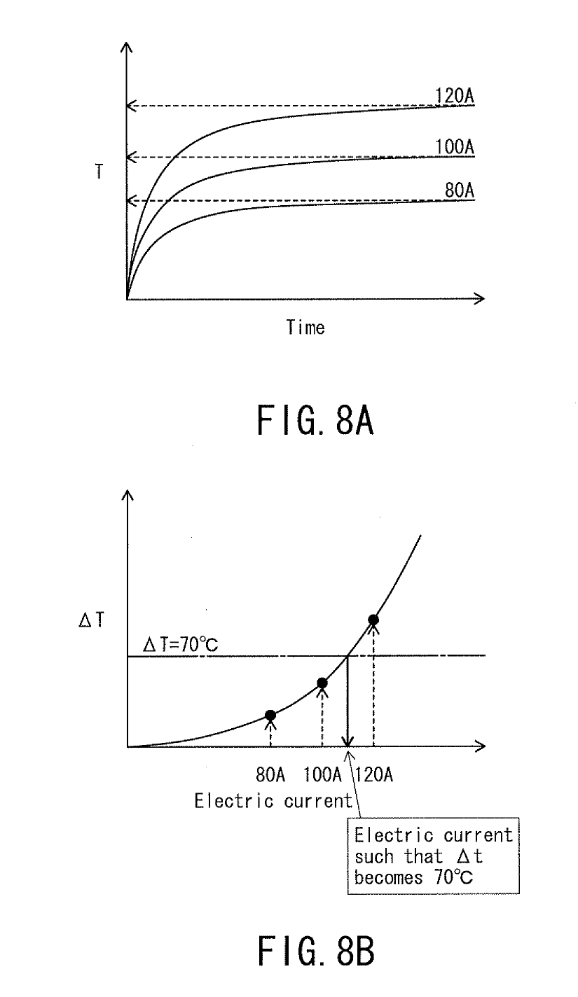

A wiring harness having a wire configuration such that three flat cables (referred to as FFC in Table 1), of which each conductor had a cross-sectional area of 14 mm², were disposed in parallel as show in Table 1 was subjected to measurement of electric current value such that ΔT, which was a difference between an ambient temperature and a heat resistance temperature, became 70 degrees C. A result of the measurement and the wire configuration are shown in Table 1. A method for measuring the electric current value is described below. Rises in temperature (T) of the wiring harness were measured by applying currents of 80A, 100A and 120A to the wiring harness as shown in FIG. 8A. The relation between the time lapsed and the temperature was plotted to obtain saturation temperatures (TSs) of the electric current values. The temperature that was obtained by subtracting an ambient temperature (TR) from the saturation temperature (TS) was assumed to be ΔT. For example, when the ambient temperature (TR) was 80 degrees C. and the saturation temperature was 150 degrees C., ΔT, which was obtained by ΔT=150-80 degrees C., became 70 degrees C. Further, the relation between ΔT and the electric current values was plotted to obtain an electric current value such that ΔT became 70 degrees C. as shown in FIG. 813. For example, the electric current value such that ΔT became 70 degrees C. defined an electric current value by which the temperature rose by 70 degrees C. when the wiring harness was used at an ambient temperature of 80 degrees C. As the electric current value becomes larger, heat generation becomes smaller and an allowable current value becomes larger.

### Comparative Example 1

For a comparison purpose, a wiring harness in which three single flat cables that were same as the cables used in Example 1 were laminated vertically (see Table 1) was subjected to measurement of electric current value such that ΔT became 70 degrees C. As a result, the electric current value of Comparative Example 1 was 98A while the electric current value of Example 1 was 126A, which showed Example 1 had the larger electric current value. cl Comparative Example 2

A wiring harness in which three single flat cables that were same as the cables used in Example 1 overlapped with one another such that the overlapping portions became ½ of the wire width as shown in Table 1 was subjected to measurement of electric current value such that ΔT became 70 degrees C. As a result, the electric current value of Comparative Example 2 was 103A, which showed that Example 1 had the larger electric current value though the electric current value of Comparative Example 2 was larger than that of Comparative Example 1.

### Reference Example 1

A wiring harness in which three conventional round wires were bunched together as shown in Table 1 was subjected to measurement of electric current value such that ΔT became 70 degrees C. As a result, the electric current value of Reference Example 1 was 125A, which was almost same as Example 1. It is to be noted that each conductor of the wiring harness of Reference Example 1 had a cross-sectional area of 20 mm², which was larger than the conductor cross-sectional area of 14 mm² of Example 1. This result showed that when the FFCs disposed in parallel were used, the conductor cross-sectional areas of the FFCs could be reduced compared with the round wires if used with same electric current value.

### Example 2

A wiring harness in which the three single flat cables used in Example 1 were disposed in parallel and covered with a shielding layer and a protection member was subjected to measurement of electric current value such that ΔT became 70 degrees C., similarly to Example 1. As a result, the electric current value of Example 2 was 102A.

### Reference Example 2

A wiring harness in which the three round wires used in Reference Example 1 were bunched together and covered with a shielding layer and a protection member that were similar to Example 1 was subjected to measurement of electric current value such that ΔT became 70 degrees C. The measurement of temperature was performed at three points shown in the wire sectional view of Table 1, and the obtained temperatures were averaged. As a result, the electric current value of Reference Example 2 was 97A, which showed Example 2 had the larger electric current value than Reference Example 2.

1-14. (canceled)

15. A wiring harness comprising:
a plurality of single flat cables, each of which has a flat shape in cross section in a width direction, and comprises:
a conductor having a flat shape; and
an insulator with which the conductor is coated; and
a protection member that is arranged to house the single flat cables, is made from a resin, and has a hollow shape, the protection member comprising
a housing space that is arranged to house the single flat cables, and disposed inside the protection member,
wherein the housing space houses the single flat cables, and the single flat cables housed in the housing space are disposed in parallel in the width direction where the flat cables are prevented from overlapping each other.

16. The wiring harness according to claim 15, wherein the protection member comprises one housing space that is arranged to house the plurality of single flat cables, wherein the plurality of single flat cables are housed in the one housing space.

17. The wiring harness according to claim 16, wherein the protection member comprises a plurality of housing spaces that are arranged to each house the single flat cables, wherein the plurality of single flat cables are each housed in the housing spaces.

18. The wiring harness according to claim 15, wherein the protection member comprises a plurality of housing spaces that are arranged to each house the single flat cables, wherein the plurality of single flat cables are each housed in the housing spaces.

19. The wiring harness according to claim 18, wherein a gap between the single flat cables and the protection member is filled with a filler that is arranged to conduct heat from the single flat cables to the protection member, and radiate the heat to the outside.

20. The wiring harness according to claim 18, wherein the protection member comprises a pair of members that are prepared by splitting the protection member in two in a thickness direction.

21. The wiring harness according to claim 15, wherein the protection member comprises a plurality of protection member units that are connected to each other, the protection member units comprising:
housing spaces that are disposed inside the protection member units, and arranged to each house the plurality of single flat cables; and
connecting members that are disposed on lateral sides of the protection member units,
wherein the protection member units, in which the single flat cables are housed in the housing spaces, are connected to each other by the connecting members disposed on their lateral sides, and the plurality of single flat cables are disposed in parallel in the width direction.

22. The wiring harness according to claim 21, wherein a gap between the single flat cables and the protection member is filled with a filler that is arranged to conduct heat from the single flat cables to the protection member, and radiate the heat to the outside.

23. The wiring harness according to claim 15, wherein the protection member is made from one of a polypropylene resin and'a polyamide resin.

24. The wiring harness according to claim 15, wherein a gap between the single flat cables and the protection member is filled with a filler that is arranged to conduct heat from the single flat cables to the protection member, and radiate the heat to the outside.

25. The wiring harness according to claim 15, wherein the protection member comprises a pair of members that are prepared by splitting the protection member in two in a thickness direction.

26. The wiring harness according to claim 15, further comprising a shielding layer provided around the single flat cables.

27. The wiring harness according to claim 26, wherein the shielding layer comprises a metallic braid.

28. The wiring harness according to claim 26, wherein the protection member has shielding characteristics that are provided by an electromagnetic wave absorption material dispersed in the protection member, or by a braid buried in the protection member.

29. The wiring harness according to claim 15, wherein the protection member has shielding characteristics that are provided by an electromagnetic wave absorption material dispersed in the protection member, or by a braid buried in the protection member.

30. The wiring harness according to claim 15, wherein ends of the single flat cables are exposed out of ends of the protection member.

31. The wiring harness according to according to claim 15, wherein the insulators of the single flat cables are made from a polyethylene terephthalate resin.

32. The wiring harness according to claim 15, wherein each of the conductors of the single flat cables comprises one of a gathering member of stranded wires that consist of elemental wires, and a gathering member of elemental wires.
